(19) United States
(12) Patent Application Publication
(10) Pub. No.: US 2004/0057463 A1
(43) Pub. Date: Mar. 25, 2004

(54) Light emitting bicycle bell with power generating means

(76) Inventor: Fon-Hsiung Fu, Hsihu Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/251,957

(22) Filed: Sep. 23, 2002

(51) Int. Cl. H04J 3/16

(52) U.S. Cl. 370/469

(57) ABSTRACT

A lighting emitting bicycle bell, which has a power generating and light emitting mechanism provided inside the casing and bell body thereof and lined to a transmission gear such that when the user operating the lever of the bicycle bell to strike strikers against protruded blocks of the bell body to ring, the power generating and light emitting mechanism is driven to generate power and to turn on light emitting diodes.

### BACKGROUND OF THE INVENTION

1. Field of the Invention

The present invention relates to bicycle bells and, more particularly, to a light emitting bicycle bell with power generating means that generates electricity to turn on light emitting diodes when operated to ring.

2. Description of the Related Art

A regular bicycle bell is generally comprised of a bell body, a lever, and a gear transmission mechanism driven by the lever to move strikers against protruded blocks inside the bell body, causing the bell body to ring. Therefore bicycle bells with light source means. According to these designs, a battery is used to provide the necessary working voltage to the light source.

### SUMMARY OF THE INVENTION

The present invention has been accomplished under the circumstances in view. It is one object of the present invention to provide a bicycle bell, which emits light when operated to ring. It is another object of the present invention to provide a light emitting bicycle bell, which generates power to turn on light emitting diodes when driven to ring. It is still another object of the present invention to provide a light emitting bicycle bell, which produces sound and light effects simultaneously when operated. To achieve these and other objects of the present invention, the light emitting bicycle bell comprises A light emitting bicycle bell comprising a casing, the casing admitting light and having a center shaft, a stepped driving gear pivoted to the inside of the casing, a lever pivoted to and partially extended out of the casing, a smoothly arched rack formed integral with one end of the lever inside the casing and meshed with the stepped driving gear, a bell body covered on the casing, the bell body having a hollow center stem fixedly fastened to the center shaft of the casing and a plurality of protruded blocks equiangularly spaced around an inside wall thereof, a transmission gear mounted on the center shaft of the casing and meshed with the stepped driving gear, and a plurality of strikers, which strike the protruded blocks of the bell body 4 to produce sound when the user operated the lever to rotate the steeped driving gear and the transmission gear, and a power generating and light emitting mechanism installed in the casing and linked to the transmission gear and driven to generate power and to turn on light emitting diodes thereof upon rotary motion of the transmission gear.

### BRIEF DESCRIPTION OF THE DRAWINGS

FIG. 1 is an exploded view of a light emitting bicycle bell according to the present invention.

FIG. 2 is a schematic sectional assembly view of the present invention, showing the light emitting bicycle bell operated.

### DETAILED DESCRIPTION OF THE PREFERRED EMBODIMENT

Referring to 1 and 2, a light emitting bicycle bell is shown comprising a casing 10, the casing 10 having a center shaft 11, a stepped driving gear 13 pivoted to the inside of the casing 10, a lever 12 pivoted to and partially extended out of the casing 10, a smoothly arched rack 120 formed integral with one end of the lever 12 inside the casing 10 and meshed with the stepped driving gear 13, a bell body 14 covered on the casing 10, the bell body 14 having a center stem 15, which has an axially extended center hole 150 fastened to the center shaft 11 of the casing 10 and a plurality of protruded blocks 16 equiangularly spaced around the inside wall, a transmission gear 21 mounted on the center shaft 11 of the casing 10 and meshed with the stepped driving gear 13, and a plurality of strikers 25, which strike the protruded blocks 16 of the bell body 14 to produce sound when the user operated the lever 12 to rotate the steeped driving gear 13 and the transmission gear 21.

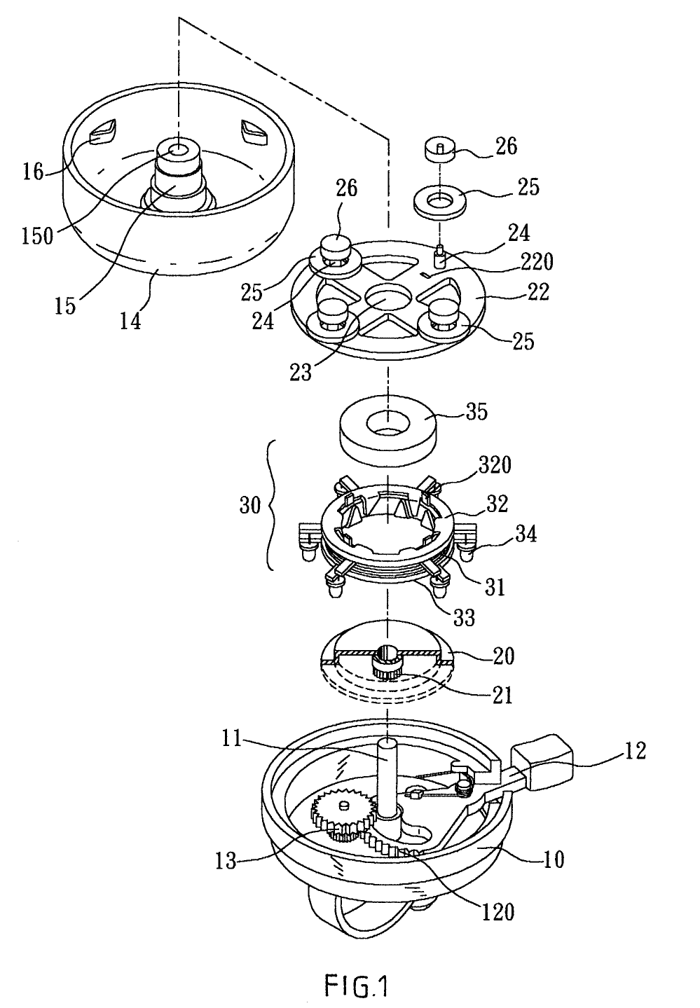

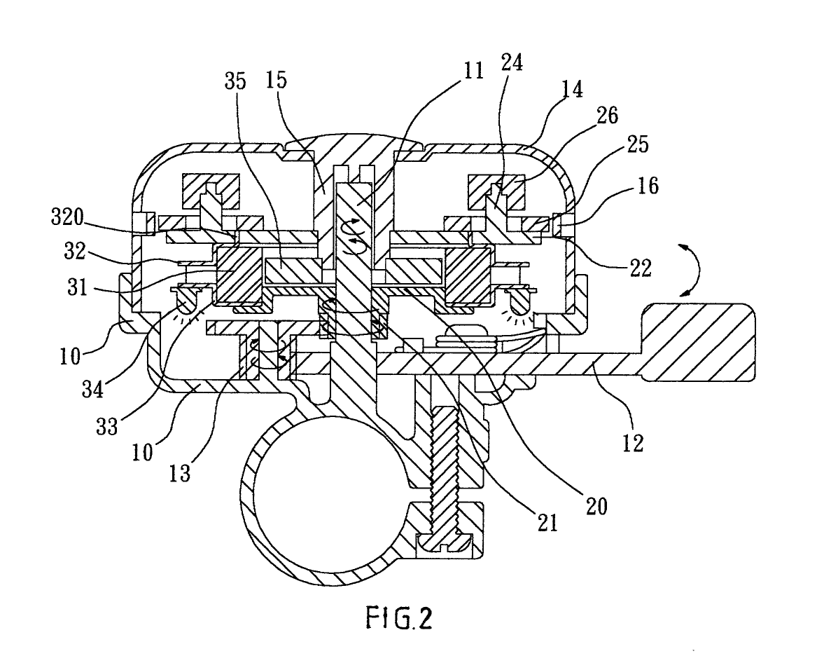

The main features of the present invention are outlined hereinafter with reference to FIGS. 1 and 2 again.

The casing 10 admits light. A power generating and light emitting mechanism 30 is installed in the casing 10 and linked to the transmission gear 21. The power generating and light emitting mechanism 30 is comprised of a winding assembly 31, a magnetic core 35, and a plurality of LEDs (light emitting diodes) 34. The winding assembly 31 is fastened to a bottom disk 20 of the transmission gear 21, having positive and negative plate electrodes 32 and 33 respectively provided at the top and bottom sides. The positive and negative lead-out wires of the LEDs 34 are respectively connected to the positive and negative plate electrodes 32 and 33 of the winding assembly 31. The magnetic core 35 is fixedly mounted on the center stem 15 of the bell body 14 within the winding assembly 31. When the winding assembly 31 rotated with the bottom disk 20 of the transmission gear 21 relative to the magnetic core 35 upon rotary motion of the stepped driving gear 13, an electric current is produced to turn on the LEDs 34.

The aforesaid strikers 25 are respectively mounted on respective upright rods 24 of a wheel 22 and secured thereto by a respective lock nut 26. The wheel 22 has a center through hole 23 for the passing of the center step 15 of the bell body 14, and a plurality of retaining holes 220 spaced around the center through hole 23. The positive plate electrode 32 of the winding assembly 31 has protruded portions 320 respectively fastened to the retaining holes 220 of the wheel 22 to secure the wheel 22 to the winding assembly 31 for synchronous rotation relative to the bell body 14.

Referring to FIG. 2 again, the casing 10 is fixedly fastened to one handlebar of the bicycle. When alternatively turning the lever 12 back and forth, the stepped driving gear 13 is driven by the rack 120 to rotate the transmission gear 21 alternatively clockwise and counter-clockwise, thereby causing the power generating and light emitting mechanism 30 to generate power and to turn on the LEDs 34, and at the same time, the strikers 25 are moved with the wheel 22 and the winding assembly 31 to strike the protruded blocks 16 of the bell body 14, causing the bell body 14 to ring. Furthermore, the aforesaid LEDs 34 can be of different colors such as blue, purple, yellow, red, white, green, etc. Therefore, a colorful lighting effect is produced when the bicycle rider operates the bicycle bell,

A prototype of light emitting bicycle bell with power generating means has been constructed with the features of FIGS. 1 and 2. The light emitting bicycle bell with power generating means functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A light emitting bicycle bell comprising a casing, said casing having a center shaft, a stepped driving gear pivoted to the inside of said casing, a lever pivoted to and partially extended out of said casing, a smoothly arched rack formed integral with one end of said lever inside said casing and meshed with said stepped driving gear, a bell body covered on said casing, said bell body having a hollow center stem fixedly fastened to said center shaft of said casing and a plurality of protruded blocks equiangularly spaced around an inside wall thereof, a transmission gear mounted on said center shaft of said casing and meshed with said stepped driving gear, and a plurality of strikers, which strike said protruded blocks of said bell body4 to produce sound when the user operated said lever to rotate said steeped driving gear and said transmission gear,
wherein said casing admits light;
a power generating and light emitting mechanism installed in said casing and linked to said transmission gear and driven to generate power and to turn on light emitting diodes thereof upon rotary motion of said transmission gear.

2. The light emitting bicycle bell as claimed in claim 2, wherein said power generating and light emitting mechanism comprises a magnetic core fixedly mounted on said center stem of said bell body, and a winding assembly fixedly fastened to said transmission gear and spaced around said magnetic core for synchronous rotation with said transmission gear relative to said magnetic core to generate electricity upon rotary motion of said transmission gear, said winding assembly having positive and negative plate electrodes disposed at top and bottom sides thereof and respectively connected to positive and negative terminals of said light emitting diodes.

3. The light emitting bicycle bell as claimed in claim 1, further comprising a wheel fixedly fastened to the positive plate electrode of said winding assembly for synchronous rotation with said winding assembly on said center stem of said bell body, said wheel comprising a center through hole for the passing of the center stem of said bell body, a plurality of upright rods equiangularly spaced around said center through hole and adapted to hold said strikers respectively, and a plurality of lock nuts respectively fastened to said upright rods to fixedly secure said strikers to said upright rods.
